(19) United States
(12) Patent Application Publication
(10) Pub. No.: US 2017/0032087 A1
(43) Pub. Date: Feb. 2, 2017

(54) SYSTEMS AND METHODS FOR SEARCHING FOR MEDICAL CODES

(71) Applicant: NotoVox, Inc., Chandler, AZ (US)

(72) Inventors: Alexandru B. TANASE, Chandler, AZ (US); Razvan VELICHE, Waltham, MA (US); Serban P. GEORGESCU, Natick, MA (US); Radu CRAIOVEANU, Hooksett, NH (US); Juhan SONIN, Arlington, MA (US); Catalin PRATA, Cluj-Napoca (RO)

(21) Appl. No.: 15/222,598

(22) Filed: Jul. 28, 2016

Related U.S. Application Data
(60) Provisional application No. 62/198,184, filed on Jul. 29, 2015.

(51) Int. Cl. G06F 19/00; G06F 17/30

(52) U.S. Cl. CPC G06F 19/328; G06F 17/30477; G06F 17/30554; G06F 17/30598

(57) ABSTRACT

Systems and methods are disclosed for searching medical codes representing medical diagnoses or procedures. One method includes: performing one or more iterations of visually selecting one of the descriptive attributes to produce search results displayed on a keyboard-like user interface, wherein the search results include other descriptive attributes and medical codes; and selecting the desired medical code from the search results, wherein the one or more iterations includes (1) an order of selecting descriptive attributes and (2) a group of descriptive attributes, and there is more than one order or more than one group of descriptive attributes that can be visually selected to produce a search result. Systems and computer readable media for executing these methods are also disclosed.

### RELATED APPLICATION(S)

This application claims priority to U.S. Provisional Application No. 62/198,184, filed Jul. 29, 2015, the entire disclosure of which is hereby incorporated herein by reference in its entirety.

### FIELD OF THE DISCLOSURE

Various embodiments of the present disclosure relate generally to search platforms and systems. More specifically, particular embodiments of the present disclosure relate to systems and methods for searching medical codes representing a medical diagnosis or procedure.

### BACKGROUND

In order to be paid by insurers, medical providers document and report the healthcare services provided to their patients. The documentation and reporting may include accurately assigning medical codes to diagnoses or procedures (including laboratory tests), directly by physicians or with help from medical coders. Some of the common “languages” used to share this medical information may be represented by coding systems such as ICD (International Classification of Diseases), DSM (The Diagnostic and Statistical Manual of Mental Disorders), CPT (Current Procedural Terminology), SNOMED CT (Systematized Nomenclature of Medicine—Clinical Terms), HCPCS (Health Care Procedure Coding System), LOINC (Logical Observation Identifiers Names and Codes), MeSH (Medical Subject Headings), UMLS (Unified Medical Language System), NDC (National Drug Code), APC (Ambulatory Payment Classification), DRG (Diagnosis Related Group), LCD/NCD (Local Coverage Determination/National Coverage Determination), Revenue Codes, and Modifiers coding systems.

The ICD is an international coding systems for reimbursement, epidemiology, and health management, which may assign specific diagnostic and procedural codes to diseases and other health conditions. In October of 2015, the US Government mandated a switch from the 36-year old, obsolete ICD-9 to a modern, detailed, and much more complex ICD-10. This brought a significant increase of the code numbers and complexity, disrupting the practice workflows and productivity.

Furthermore, current medical coding approaches may be slow and inefficient. One common method for coding medical codes by medical professionals or medical insurance providers is manual coding, despite being labor intensive and having low productivity. Coders may need to use several monitors to review a patient chart while consulting a local or online resource.

In traditional coding-related lexical searches, users may type a few key words and may get a long list of results, which they need to browse. Users may be reluctant to go to the second or subsequent pages of search results, and may settle on one of the first few results, usually one of the more non-specific codes, or start over with a refined set of words for a subsequent search. In addition, mapping between ICD-9 and ICD-10 (forward and backward mapping) used in many applications may be inefficient, as only 5% of the codes may map 1 to 1. Thus, current coding methods may not be as intuitive for users, and may make it hard for users to find what they are looking for, unless they know the exact name of a database entry.

Computer Assisted Coding may be a more recent approach that may use software integrated into Electronic Medical Records to automate the coding process. It may scan the patient chart for key words, and through Natural Language Processing, it may suggest a list of codes which may need to be validated by coders and physicians. However, Computer Assisted Coding may be expensive and may rely on a difficult variable in the practice, non-standard patient documentation. Two physicians who see the same patient at the same time may document their observations differently, their notes being dependent on their background, education, gender, age, emotional state, etc.

The task of coding also may be complicated by other factors. For example, a disease can be described using various names. A disconnect may exist between physicians who document a medical diagnosis or procedure into the medical record, and coders who may determine which codes are to be selected by reviewing the patient chart. The interaction between these two groups may need to include both a clear and detailed physician description of the patient's current health state, and extensive knowledge of anatomy and physiopathology by coders.

Accurate coding and documentation of patients' diagnoses, complications and comorbidities, and their treatments, may be important as it may directly affect revenue, including future pay for performance metrics, clinical outcomes and public health. There is a need to standardize the capture of medical events (observations, conditions and treatments) through coding, in a consistent and uniform way which is generally accepted by the medical community.

Thus, there is a desire for a system and method of searching medical codes representing a medical diagnosis or procedure, which is fast and efficient, precise in its coding, intuitive for the user, and does not require rigorous training on the part of users. There is also a desire for a platform and user interface that would enable the system and method of searching for medical codes representing a medical diagnosis or procedure, which may be able to facilitate access to complex and precise coding systems (e.g., ICD-10).

### SUMMARY

The foregoing general description and the following detailed description are exemplary and explanatory only and are not restrictive of the disclosure. According to certain aspects of the present disclosure, systems and methods are disclosed for searching medical codes representing a medical diagnosis or procedure.

One method includes: performing one or more iterations of visually selecting one of the descriptive attributes to produce search results displayed on a keyboard-like user interface (“The Technological keyboard”), wherein the search results include other descriptive attributes and medical codes; and selecting the desired medical code from the search results, wherein the one or more iterations includes (1) an order of selecting descriptive attributes and (2) a group of descriptive attributes, and there is more than one order or more than one group of descriptive attributes that can be visually selected to produce a search result.

In accordance with another embodiment, a system for searching medical codes representing a medical diagnosis or procedure comprises: a data storage device storing instructions for enabling a user to search for a desired medical code of the medical codes; a user interface enabling the user to search for the desired medical code, wherein descriptive attributes are assigned to each of the medical codes, at least some of the descriptive attributes including categories comprising other of the descriptive attributes; and a processor configured to enable the user of the system to: perform one or more iterations of visually selecting one of the descriptive attributes to produce search results displayed on a keyboard-like user interface, wherein the search results include other descriptive attributes and medical codes; and select the desired medical code from the search results, wherein the one or more iterations includes (1) an order of selecting descriptive attributes and (2) a group of descriptive attributes, and there is more than one order or more than one group of descriptive attributes that can be visually selected to produce a search result.

In accordance with another embodiment, a method for enabling a user to search for medical codes representing medical diagnoses or procedures, the method comprises: storing medical codes in an electronic storage medium; assigning descriptive attributes to each of the medical codes, at least some of the descriptive attributes including categories comprising other of the descriptive attributes; receiving an input from the user, wherein the input is a selection by a user of one of (a) the descriptive attributes, (b) the medical codes, or (c) the keyboard functionalities to view more descriptive attributes or medical codes, displayed on a keyboard-like user interface, and wherein the input does not include the user typing alphanumeric text of the one of the descriptive attributes, medical codes, or the keyboard functionalities; if the received input is a descriptive attribute or a keyboard functionality, producing and displaying search results on the keyboard-like user interface, wherein the search results include other descriptive attributes and medical codes; and if the received input is matched to a medical code, producing and displaying the medical code on the keyboard-like user interface.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments.

FIG. 1 is a block diagram of an exemplary system and network of searching for medical codes representing a medical diagnosis or procedure, according to an exemplary embodiment of the present disclosure.

FIG. 2 is an exemplary user interface of a platform for searching for medical codes representing a medical diagnosis or procedure, according to an exemplary embodiment of the present disclosure.

FIG. 3A is an exemplary user interface (part of the “Technological keyboard”) of the hierarchical results area of a platform for searching for medical codes representing a medical diagnosis or procedure, according to an exemplary embodiment of the present disclosure.

FIG. 3B is an exemplary user interface (part of the “Technological keyboard”) of the filters and tags of a platform for searching for medical codes representing a medical diagnosis or procedure, according to an exemplary embodiment of the present disclosure.

FIGS. 4A-4J are a series of exemplary screenshots of a platform for searching for medical codes representing a medical diagnosis or procedure, depicting an exemplary method of searching for medical codes representing an exemplary medical diagnosis or procedure (e.g., Type 2 diabetes mellitus with mild nonproliferative diabetic retinopathy with macular edema).

FIG. 5 is a flow diagram of an exemplary search process performed by the platform for searching for medical codes representing a medical diagnosis or procedure, according to an exemplary embodiment of the present disclosure.

FIGS. 6A-6B are hierarchical tree diagrams depicting and comparing methods of searching for medical codes representing a medical diagnosis or procedure, according to an exemplary embodiment of the present disclosure.

### DETAILED DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

As described above, a desire exists for a system and method of searching medical codes representing a medical diagnosis or procedure, which, in embodiments, is, one or more of, fast and efficient, precise in its coding, intuitive for the user, and does not require rigorous training on the part of users. Furthermore, a desire exists for a platform and user interface that, in at least certain embodiments, would enable the system and method of searching for medical codes representing a medical diagnosis or procedure, which may be able to facilitate access to and conversion between complex and precise coding systems (e.g., ICD-9, ICD-10, etc.).

The exemplary embodiments of systems and methods described in the present disclosure may allow for a quick and clear visualization of the ICD-10 structure/options of coding for users, and may be a solution to at least some of the current problems caused by the government mandated switch to the ICD-10 coding language, including the difficulty in the mapping of codes from other medical “languages” (terminologies, classifications, ontologies, etc). Through the platform for searching medical codes representing medical diagnoses and procedures, as described below, physicians may be able to learn the ICD-10 CM “language” based on their existent knowledge, without needing rigorous training.

To facilitate the transition into ICD-10, the platform described in embodiments of the present disclosure allows cross-referencing of a target taxonomy (ICD-10) with helper taxonomies (SNOMED, DMS-5), and an extraction and classification of elements used in describing an ICD-10 code (or any other taxonomy). This means that representation of healthcare information in an organized, consistent and reusable way may involve various structures (e.g., coding languages) for various purposes. For example, the ICD is the global health information standard for mortality and morbidity statistics. SNOMED is the most comprehensive, multilingual clinical terminology in the world. The Diagnostic and Statistical Manual of Mental Disorders (DSM) is the standard classification of mental disorders used by mental health professionals in the US. In each of the above systems, similar medical concepts are described differently and organized at various degrees of granularity while preserving their semantic meanings. In the US, the mandated structure for billing purposes (ICD-10) is designed for statistics which is not optimal for the representation of the clinical process. SNOMED and DSM structures offer more practical alternatives and have partial standardized mappings to ICD-10.

Thus, cross-referencing may refer to the feature described in various embodiments of the present disclosure that may allow users to choose the most accurate concepts from any of the described structures (e.g., coding languages) in a consistently semantic way.

For purposes of demonstration, the embodiments described below relate to a system and method of searching for ICD-10 codes representing a medical diagnosis or procedure. However, the systems and methods described may be used to search for medical codes in other standardized languages for coding (including other versions of the ICD), and the platform may enable the conversion and/or translation of medical codes from one standardized language to another standardized language. Irrespective of the coding language chosen (e.g., ICD-10, DSM-5, SNOMED, etc.), a corresponding list of ICD-10 codes (based on official mappings) may be assigned for billing or other purposes.

The systems and methods described in the present disclosure may, in at least some embodiments, solve the inefficiencies of current coding methods and coding related searches, by presenting a platform for searching medical codes, which is intuitive for the user, and precise in the search results. A user may be able to search on this platform without having to type, for example, by choosing elements from groups of features from a user interface as described below. The user interface may enable users to, one or more of: quickly check one or more recent selections that led to the results of a search; use different types of filters (e.g., a user may choose to filter by anatomy, after having exclusively filtered by “specialty” during a given search process); be guided and/or helped by the application (e.g., by being presented with only relevant filter choices); and/or be worry-free about a wrong filter selection and potentially “losing work” (e.g., by still keeping the other filters active, after removing a given filter, as per user's choice). Thus, the systems and methods of searching medical diagnoses and procedure may enable, one or more of: multi-tagging, multi-filtering visual search of complex medical taxonomy; a flexible orienteering-based navigation towards a result; a ready access and/or view of search filters and/or tags that have been already applied during a search session; a visual feedback for “next steps;” an ability to apply other filters or taxonomies to narrow down the choices, including filters that may be radically different from recently used filters of a search session; an ability for users to add observations to further filter down towards fewer results; and/or multiple paths/selections to the same result.

As will be described further, the user interface may have various user-friendly features that may overcome the one or more problems of current search methods and/or platforms. These features may include one or more display of results in groups of four (e.g., 2×2 grids for fast cognitive review); a parallel display of the main results and the main attribute group options; a refinement of results by hierarchical structure and/or attributes; a display of text and icons on buttons for easy identification; a flexible workflow (e.g., enabling a user to review, change, add, cancel, and/or reset results and attributes at any step, in any order); the enablement of a retrieval of pre-coordinated values irrespective of order of choice; a minimization of the possibility of creating duplicates; a hybrid search feature, by allowing lexical searches, searches by attributes, and hierarchical searches to be combined in any order, at any step; an evolving search, whereby a user may query, quickly skim results, learn, adapt, change the direction of a search, and/or refine a query; an orienteering-based search feature, whereby a user may use currently displayed information to determine where to go next; an ability to follow the progress of a search in real-time to predict the direction of a search and allow the redirecting of a search, if necessary; a flexible, and context-specific orienteering navigation, through the user interface and its combination of filters, for example, where each selected filter, tag, and/or result may impact other filters, tags, and/or results, irrespective of the order of choice or position on the keyboard; an ability to cancel any chosen filter and/or tag individually, while keeping the other choices, regardless of their selection order; and an ability to have any given offerings of choices in a user interface reflect a user's cognitive decision (controlled/focused search), allowing a user with minimum knowledge about a desired code to review available options (all in ICD-10 “vocabulary”) and narrow down choices quickly.

The systems and methods of the present disclosure may, in at least certain embodiments, overcome the problems posed by inconsistencies of observations between various medical professionals and coders, by providing a poly-hierarchical platform that may lead to standardized patient documentation. Coders may be able to search based on elements found on patient charts, for example, unspecified codes, history (e.g., Signs/Symptoms), physical findings (e.g., Anatomy), pathology and/or other familiar terms (e.g., tumor, infection, etc.). The dynamic display and interactions between codes, hierarchical groups, anatomical elements, and anatomical groups in the user interface may allow users to review and use the existing structure and choices in the classifications for even more detailed search refinements. Instead of restricting the use of a coding language (e.g., ICD language system) to a mono-hierarchical structure, at least certain embodiments of the systems and methods of the present disclosure may utilize coding languages as a “poly-hierarchic analytical data.” In other words, a user may reach a desired medical code using more than one path, each path going through a different set of descriptive attributes and/or categories of descriptive attributes.

Furthermore, embodiments of the systems and methods of the present disclosure may be designed to allow the user to have greater flexibility in navigating towards a result (e.g., a user may start with “Body” or “Specialty” as filters, even though the starting filters may be very different). This means that doctors, coders, or other users can structure their observation in a consistent way. Consequently, richer information may by captured at the code level, while providing the user with multiple starting points or pathways in the search process. Each code may provide for a free-text entry—basically notes of the physician that may help in documentation, or for future reference, etc. In some embodiments, the user interface for searching may provide instant feedback on necessary documentation. Thus, at least certain embodiments of the systems and methods of the present disclosure may enable the re-creation of the full observation made during a visit from the elements (and possibly the navigation path taken) during that visit.

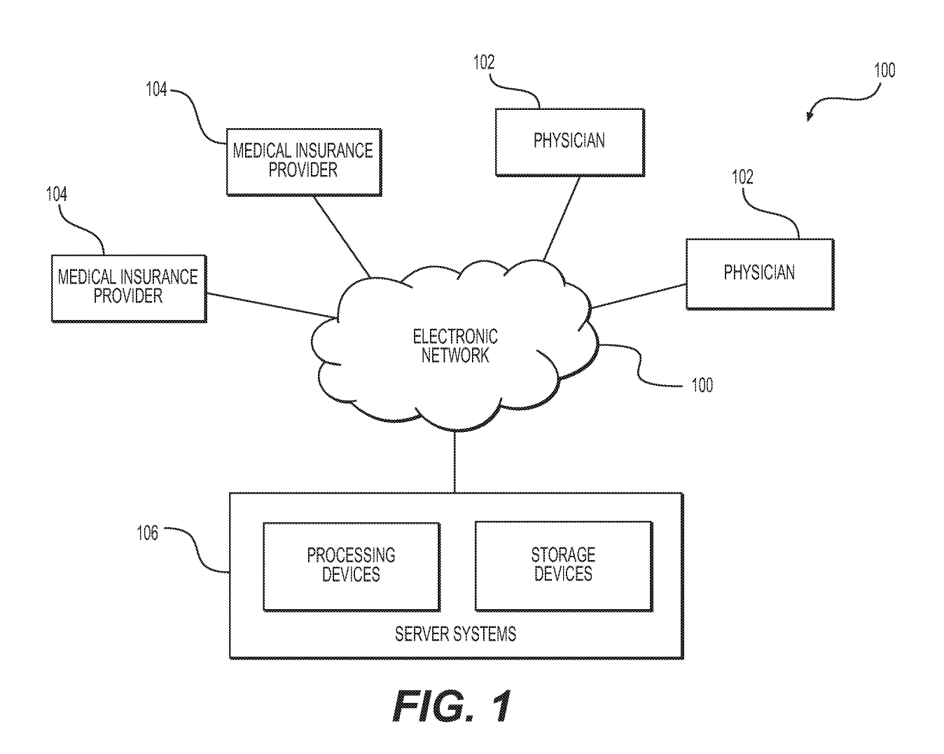

Referring now to the figures, FIG. 1 depicts a block diagram of an exemplary system 100 and network for searching for medical codes representing a medical diagnosis or procedure, according to an exemplary embodiment. Specifically, FIG. 1 depicts a plurality of physicians (or other users) 102 and medical insurance providers 104, any of whom may be connected to an electronic network 101, such as the Internet, through one or more computers, servers, and/or handheld mobile devices. Physicians 102 and/or medical insurance providers 104 may input or otherwise obtain medical codes representing a medical diagnosis or procedure for a patient. For purposes of the disclosure, a “patient” may refer to any individual or person for whom a medical diagnosis or procedure is being performed or recorded, or for whom the medical code representing the medical diagnosis or procedure is being obtained. In some embodiments, a “patient” may also refer to any individual or person associated with the medical diagnosis or procedure. The physicians 102 and/or medical insurance providers 104 may also obtain any combination of patient-specific parameters, including patient characteristics (e.g., age, medical history, etc.) and physiological characteristics (e.g., blood pressure, blood viscosity, patient activity or exercise level, etc.). Physicians 102 and/or third party providers 104 may transmit the medical codes and other data to server systems 106 over the electronic network 101. Server systems 106 may include storage devices for storing medical codes and other data received from physicians 102 and/or third party providers 104. Server systems 106 may also include processing devices for processing medical codes and other data stored in the storage devices. In some embodiments, server systems 106 may comprise of a back end server (“cloud”) feeding medical codes and other data into a front end server, the front end server having a short-term storage device.

Embodiments of the present disclosure include a user interface, which may be designed for reducing the cognitive load by the user while searching or obtaining medical codes for medical diagnoses or procedures, and which may enable an intuitive, context-sensitive, history-tracking, attributes-based orienteering/navigation towards a medical code.

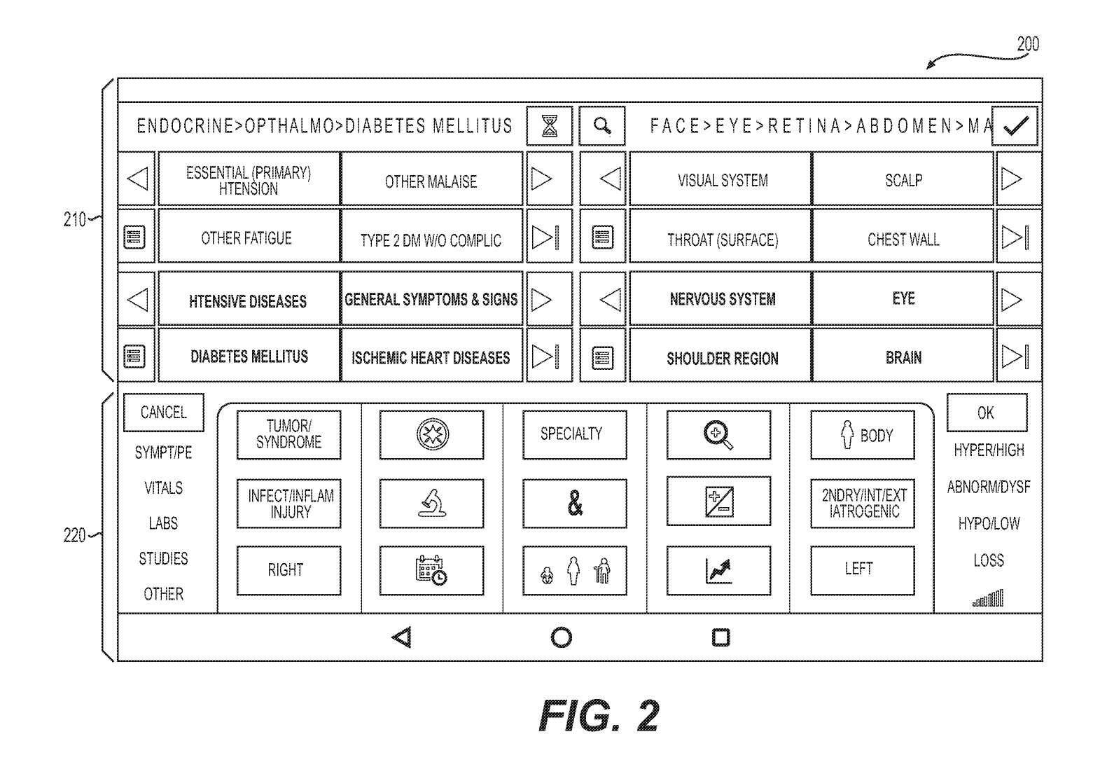

FIG. 2 is an exemplary user interface of a platform for searching for medical codes representing a medical diagnosis or procedure, according to an exemplary embodiment of the present disclosure. The user interface may enable the user to a visual, intuitive, no-typing search based on medical terms which are familiar to users. In some embodiments, the systems and methods of searching, as described in the present disclosure, may allow users search complex medical codes in under 30 seconds. Thus, the user interface, described in at least some embodiments of the current disclosure, may be an enhanced form of an electronic keyboard (“technological keyboard”), which may contain intuitive buttons representing technical concepts (medical attributes) which may be known by the users in the healthcare industry.

As depicted in FIG. 2, a user interface (e.g., technological keyboard) may be a screen with a plurality of main buttons organized into a keyboard-like display (“user interface”) 200. The user interface 200 may have two parts: an upper half, e.g., “hierarchical results area” 210, showing the search results, and a lower half, e.g., “filters and tags area” 220, showing options for filtering, narrowing, and/or broadening a search based on filters and tags. A search may be defined as one or more attempts to limit the possibilities for a medical code to describe a medical diagnosis or procedure, using the buttons of the filters and tags area and the hierarchical results area to limit the possibilities. The final goal of a search may be to find a valid ICD-10 code (displayed in the upper left area of the hierarchical results area 210) with the best description (granularity) for the patient's condition. In another embodiment, the final goal may be to find a valid medical code in one or more other standardized “languages” available for sharing medical information, in addition to, or as an alternative to, the ICD-10. These languages may include other versions of the ICD (e.g., ICD-9), SNOMED CT, DSM, etc.

The user interface 200 (e.g., technological keyboard) may facilitate the ease of the search process by encoding information in a format that is familiar for the user (e.g., concepts learned in medical training). Users may start from any point and navigate a desired path of choices which follows their natural way of thinking about that medical code.

Users may search for concepts by activating the graphical buttons which contain suggestive images or text representing the sought-after concepts. Furthermore, the buttons may be linked to each other. For example, if a filter or tag button is activated, the keyboard offering may change accordingly, in the hierarchical results area 210 and/or the filters and tags area 220. Likewise, if a button in the hierarchical results area 210 is clicked or otherwise selected, the keyboard offering may change accordingly, in the hierarchical results area 210 and/or the filters and tags area 220. Thus, the two parts of the user interface, the hierarchical results area and the filters and tags area, may be ontologically linked to each other, and act as filters against each other. By enabling bi-directional filtering, at least certain embodiments of the systems and methods of the present disclosure may guide the user to the most granular result in the most efficient way (fewest buttons pressed/selected).

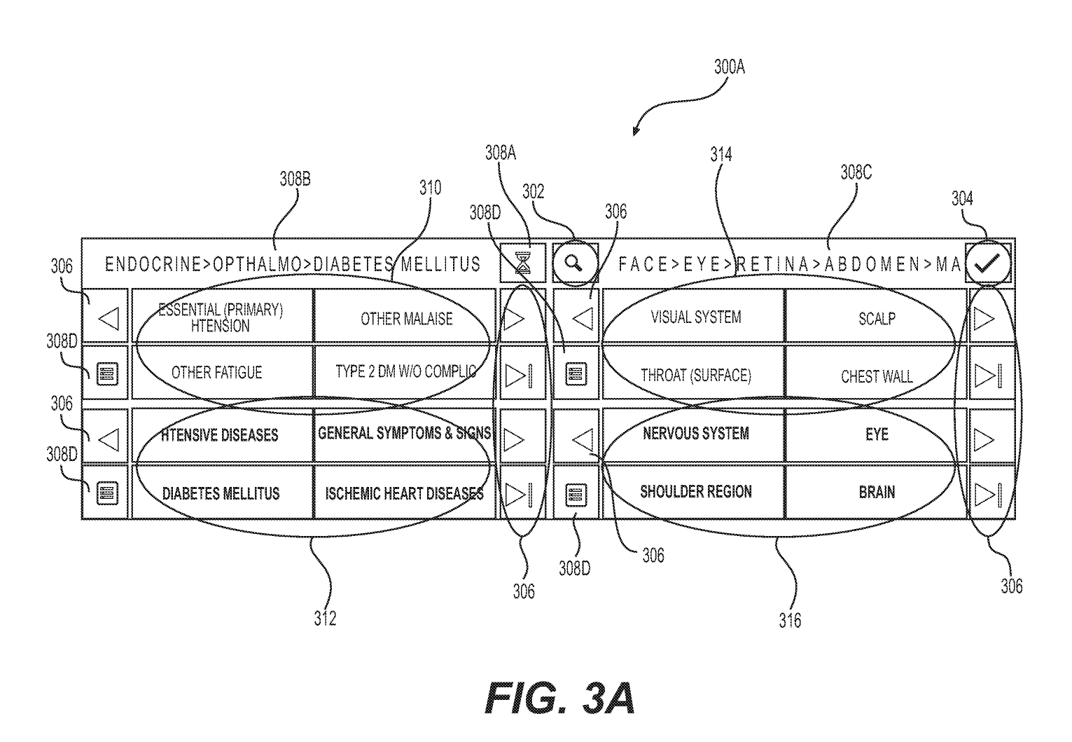

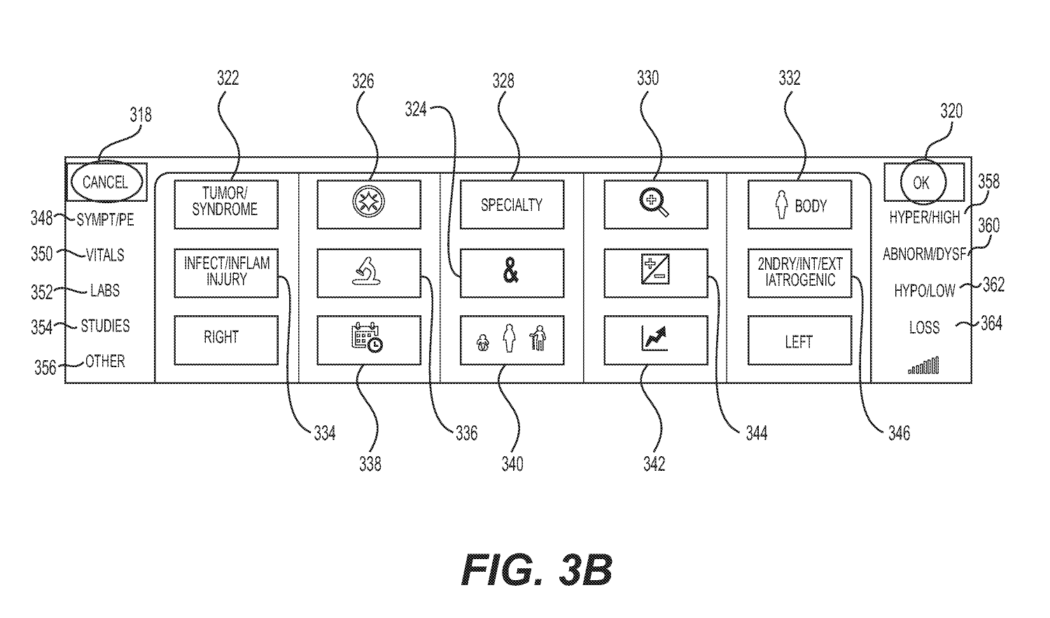

While FIG. 3A describes an exemplary embodiment of the hierarchical results area 300A of the user interface 200 in further detail, FIG. 3B describes an exemplary embodiment of the filter and tags area 300B of the user interface 200 in further detail.

The hierarchical results area 300A (upper half of the user interface 200) may be organized into a plurality of zones, e.g., four zones as depicted in FIG. 3A. For example, a zone at the upper left 310 of the hierarchical results area 300A may display the final ICD-10 codes. A zone at the lower left 312 of the hierarchical results area 300A may display the hierarchical disease groups corresponding to the ICD-10 codes in the upper left 310. A zone at the upper right 314 of the hierarchical results area 300A may display anatomical elements corresponding to the ICD-10 codes at the upper left. For example, the anatomical elements corresponding to the ICD-10 codes, as depicted in FIG. 3A, may include the visual system, the scalp, the throat (surface), the chest wall, etc. A zone at the lower right 316 of the hierarchical results area 300A may display the anatomical groups corresponding to the ICD-10 codes at the upper left and the anatomical elements at the upper right. The anatomical groups may allow the organization and visualization of the anatomy at a “higher hierarchical level” and may subsequently enable the user with a faster access to more specific anatomical elements in the zone at the upper right.

On an abstract level, the upper left and lower left zones may be considered as being part of the disease and/or diagnostics side of the hierarchical results area while the upper right and lower right zones may be considered as being the anatomical side of the hierarchical results area. In some embodiments, where one or more searches have been performed resulting in changes in the disease and/or diagnostics side or the anatomical side, a user may use “prior selections buttons” 308D near the disease and/or diagnostics side or the anatomical side, respectively, to access the previously accessible results in the upper left, lower left, upper right, or lower right zones. In some embodiments, a search history icon 308A may allow the displaying of the codes already chosen by the user in a specific time interval. In other embodiments, the user interface may display, at the top of the disease and/or diagnostics side of the hierarchical results area, an indication of the previously selected disease groups, diseases, and/or medical diagnoses or procedures (“breadcrumbs for disease groups and diagnoses” 308B). Likewise, the user interface may display, at the top of the anatomical side of the hierarchical results area, an indication of the previously selected anatomical groups and/or anatomical elements (e.g. “breadcrumbs for anatomical groups and elements” 308C).

Each zone of the hierarchical results area 300A (e.g., upper left 310, lower left 312, upper right 314, lower right 316) may have results of a search presented in 2×2 grids, to make it efficient for human review. In some embodiments, the user interface may enable the user to scroll and view more results in the 2×2 grids, (e.g., via scrolling tools 306). Inside each grid, the results may be presented in a user-adjustable preference order, with a default provided either by frequency of usage or by existing subject matter expertise. Information within one grid may be correlated to information within another grid either hierarchically or semantically. Hierarchically, for example, refers to when information presented in one grid may be considered to be a subgroup and/or element of information presented in another grid. Semantically, for example, refers to when information presented in one grid may be considered to be related to information presented in another grid conceptually and/or by definition. In some embodiments, the grids may be arranged to be of any length or width and therefore display more than four results at a time (e.g., 2×3, 2×4, 3×3 grid, 4×4 grid, 5×5 grid, etc.)

In some embodiments, the right hand side of the hierarchical results area may correspond to other taxonomies for classifying a medical code (e.g., DSM-V, SNOMED, etc.), in addition to, or as an alternative to, corresponding with the anatomical descriptive attributes of a medical code. For example, the upper right zone may include the elements of one or more additional taxonomies (e.g., elementary classifications within the coding languages of the DSM-V, SNOMED, etc). In such embodiments, the lower right zone may include the hierarchical groups of the elements of the additional taxonomies, under which the elements of the additional taxonomies can be classified.

In some embodiments, in addition to the buttons at the filters and tags area of the user interface acting as dynamic filters, the results displayed at the hierarchical results area 300A of the user interface (e.g., the buttons in the upper right, lower right, and lower left zones) may also act as dynamic filters, allowing a further refinement of the search process, resulting in a new offering of buttons in the hierarchical results area and/or filters and tags area. In some embodiments, a user may access the history of a recent search, for example, via the prior selections button 308D next to each zone of the hierarchical results area 300A, the search history button 308A, the breadcrumbs for disease groups and diagnoses 308B, and/or the breadcrumbs for anatomical groups and elements 308C. Furthermore, dividing the results of a search (e.g., the buttons in the hierarchical results area) into groups (e.g., the four zones as depicted in FIG. 3A) may offer additional ways to navigate (e.g., hierarchically) into the data set tree. Group results may drive the specific results, and vice versa. This means that for each code (in the left upper area), the corresponding higher hierarchical disease groups may be displayed in the lower left area, the corresponding anatomical groups may be displayed in the lower right area, and the corresponding anatomical elements may be displayed in the upper right area. The user may recognize a code displayed in the upper left area as being somewhat similar to what he or she may be about to choose. Once that code has been selected, the hierarchical groups in which the medical code belongs to (e.g., the disease groups in the lower left zone, the anatomical elements in the upper right zone, and the anatomical groups in the lower right zone) may then be available. The resulting search results within these zones may subsequently be displayed in the first page and/or initial screen of the grid. A user may scroll through different pages and/or screens of a zone and/or grid, for example, using the arrows 306 and/or other keyboard functionalities. Within the grids, the results may be shown preferentially (first from the left) irrespective of where the initially recognized code was displayed in the upper left grid (e.g., whether the initially recognized code was displayed in the first page of results in the upper left grid, the second page of results in the upper left grid, the last page of results in the upper left grid, etc.). Choosing any of the available upper hierarchical disease groups of the lower left zone, related anatomical elements of the upper right zone, or related anatomical groups of the lower right zone may allow access to other codes in the upper left zone, which may be conceptually related to the initially selected medical code, without the need for choosing any of the descriptive attributes available in the filters and tags area (e.g. 220 of FIG. 2) of the user interface.

FIG. 3B depicts the filters and tags area 300B (e.g., 220 of FIG. 2) in greater detail, according to an exemplary embodiment of the present disclosure. In some embodiments, the filters and tags area quickly orients the user on the available choices (filters) and reduces the uncertainty in dealing with a vast number of choices to code for or obtain the code for a medical diagnosis or procedure. In one embodiment, as depicted in FIG. 3B, the filters and tags area may have a plurality of buttons (e.g., 25 buttons), and each button may open up a submenu of choices. For example, the button 328 for “Specialty” opens up choices for Cardiology, Endocrinology, Neurology, Ophthalmology, etc. In another example, the button 326 for “Pattern Change” opens up choices for “Anterior”, “Posterior”, “Medial”, “Lateral”, “Superficial”, “Deep”, etc.

These buttons may be natural/intuitive to the medical personnel and are designed to minimize and/or eliminate the learning curve necessary to utilize the application effectively. For example, the button 336 for “Pathology” may prompt the user to consider abnormal effects of diseases. The buttons containing the filters and/or tags may have easily recognizable names (e.g., specialty, body, hyper/high, loss, vitals, studies, etc.) and/or easily recognizable symbols (e.g., pathology, zoom, orientation, timing, biological periods, time patterns, etc.). As depicted in FIG. 3B, these buttons may include, but are not limited to the following: tumor/syndrome 322, which may provide the choices of malign, benign, or syndrome; numeral 324, which may provide the choices of single, one, multiple, poly, mixed, etc.; pattern change 326, which may provide the choices of anterior, posterior, medial, lateral, etc.; specialty 328, which may provide the choices of cardiology, neurology, endocrinology, respiratory, etc.; anatomical elements 330, which may provide the choices of skin, muscle, joint, tissue, cells, etc.; body parts 332, which may provide the choices of head, neck, upper extremities, thorax, etc.; infection/inflammation/injury 334, which may provide the options of infection, inflammation, or injury; pathology 336, which may provide the options of infarction, ischemia, nodule, ulcer, etc.; timing 328, which may provide the options of acute, chronic, primary, secondary, early, late, etc.; bio-periods 340, which may provide the options of congenital, pregnancy, juvenile, childhood, adult, etc.; time-patterns 342, which may provide the options of continuous, cyclical, intermittent, paroxysmal, recurrent, etc.; status 344, which may provide the options of addiction, deteriorating, failure, healing, improving, etc.; and secondary to 346, which may provide the options of external, internal, or iatrogenic.

In some embodiments, as depicted in FIG. 3B, the filters and tags area may also have further buttons, e.g., symptoms/physical examinations (abbreviated as “sympt/PE”) 348, vitals 350, labs 352, studies 354, hyper/high 358, abnormalities/dysfunctions (abbreviated as “abnorm/dysf”) 360, hypo/low 362, loss 364, other 356, etc., and each button may open further options. For example, selecting “labs” 352 may enable the user to select one of many options, for example, blood test, calcium test, CBC test, etc.

In some embodiments, the filters and tags, accessible via buttons in the filters and tags area, may be interdependent on one another. In other words, the choice of options that may be presented when selecting a main button (e.g., “pathology”) may depend on whether another main button (e.g., “specialty”) or an option within said another main button (e.g., “endocrine”) has been selected. Furthermore, the display of these interdependent filters may be dynamic and depend on the search context. This means that the selection of one filter may influence the next set of filters to be displayed on the screen.

To make it easier for a user to select a filter and/or tag, or choose an option within a selected filter and/or tag, the cancel button 318 and OK button 320 may also be provided on the user interface. For example, after a user has selected a filter or tag (e.g., specialty) resulting in a list of options (e.g., list of specialties to select), a user may unselect the filter or tag (e.g., unselect specialty) using the cancel button 318. Alternatively, the user may select an option from a list of options (e.g., list of specialties), and then use the OK button 320, to finalize a specific option of a filter or tag.

Thus, the buttons, selections, and/or results of the hierarchical results area and/or the filters and tags area may be arranged intuitively for the workflow used by the target audience. The hierarchical results area 300A (e.g., 210 of FIG. 2), which may include 2×2 grids at the various zones, may be complemented by the filter and tags area 300B (e.g., 220 of FIG. 2), which may include an area of reactive buttons encoding filters and properties of results, dimmed or not according to their availability, whose content is adapted on-the-fly to reflect the semantic meaning of the navigation and selections made by the user up to that point.

In some embodiments, the user interface may also provide the user with a search button (e.g., 302 in FIG. 3A) enabling the user to perform a conventional text search for a medical diagnosis or procedure, filter, tag, and/or result. A text search may include, for example, a step of receiving alphanumeric identifiers (e.g., ASCII keys) as inputs by a user, and matching a sequence and/or array of the alphanumeric identifiers to a descriptive attribute, filter, tag, hierarchical result, and/or medical diagnosis or procedure. In the embodiments shown in the figures, and described in their corresponding text, the medical code searching is done without any coice regnition searching. In yet another embodiment, however, the user interface may also enable the user to search for descriptive attributes (e.g., filters, tags, hierarchical results, medical codes, etc.) by voice recognition. For example, a user may speak, into a microphone that is affixed to or is a part of the user interface, the descriptive attribute and/or medical code that he or she wishes to search for. In such embodiments, the platform may utilize voice recognition technology to match the recording and/or sound file sent by the user to the appropriate descriptive attribute and/or medical code using voice recognition technology.

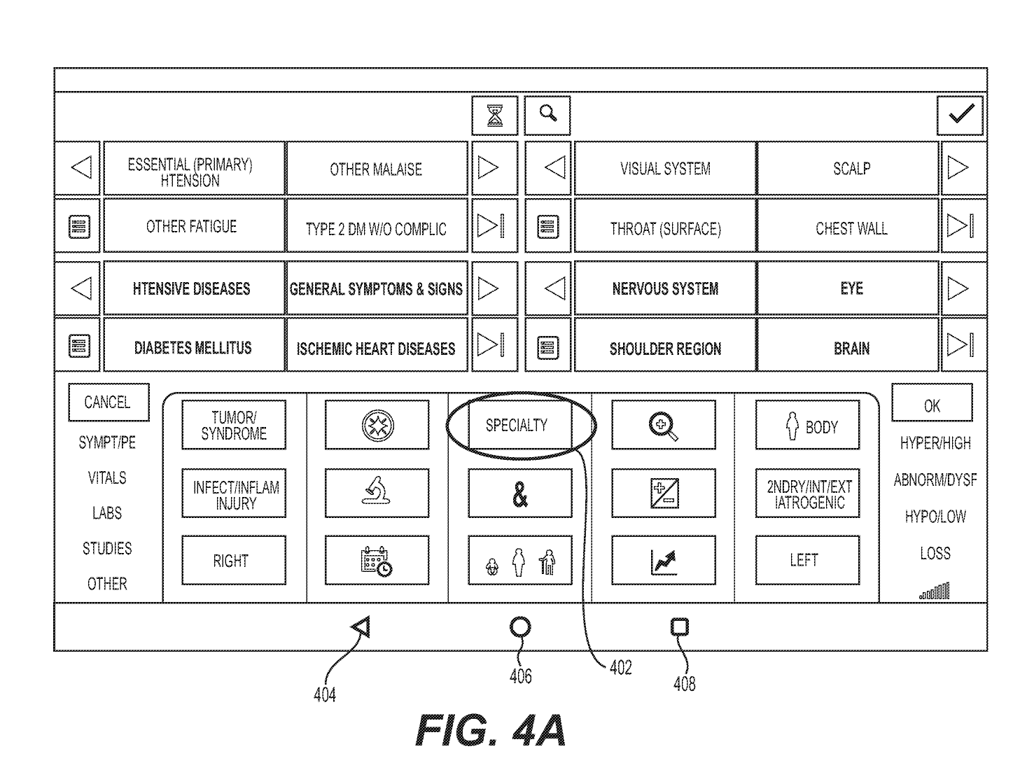

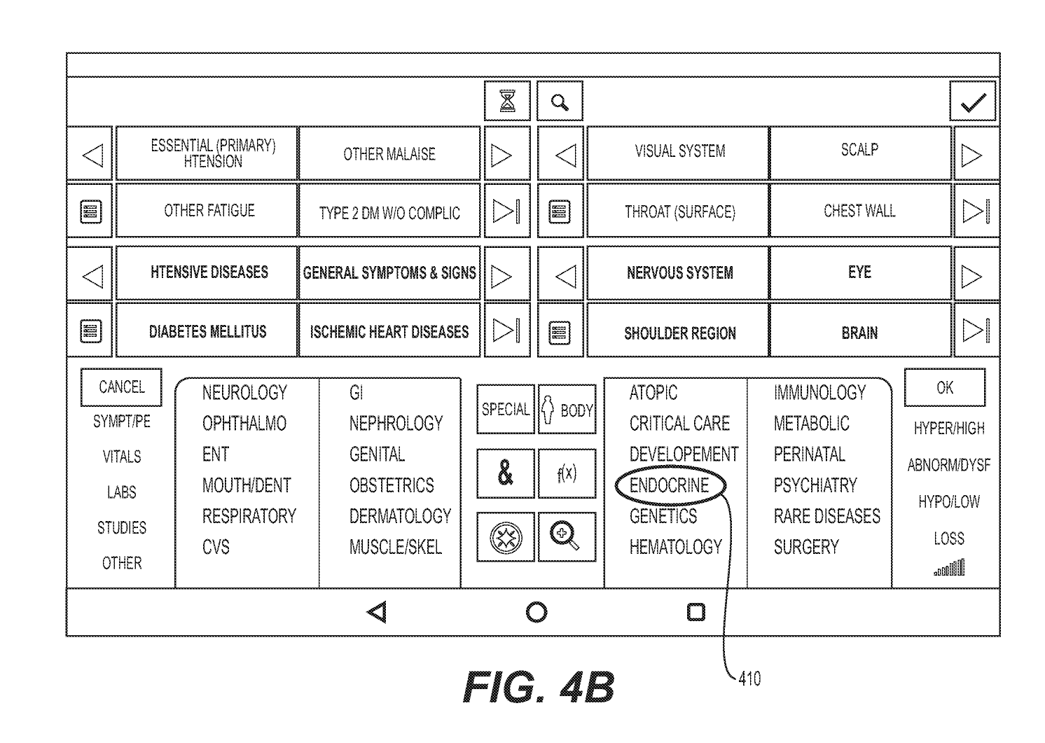

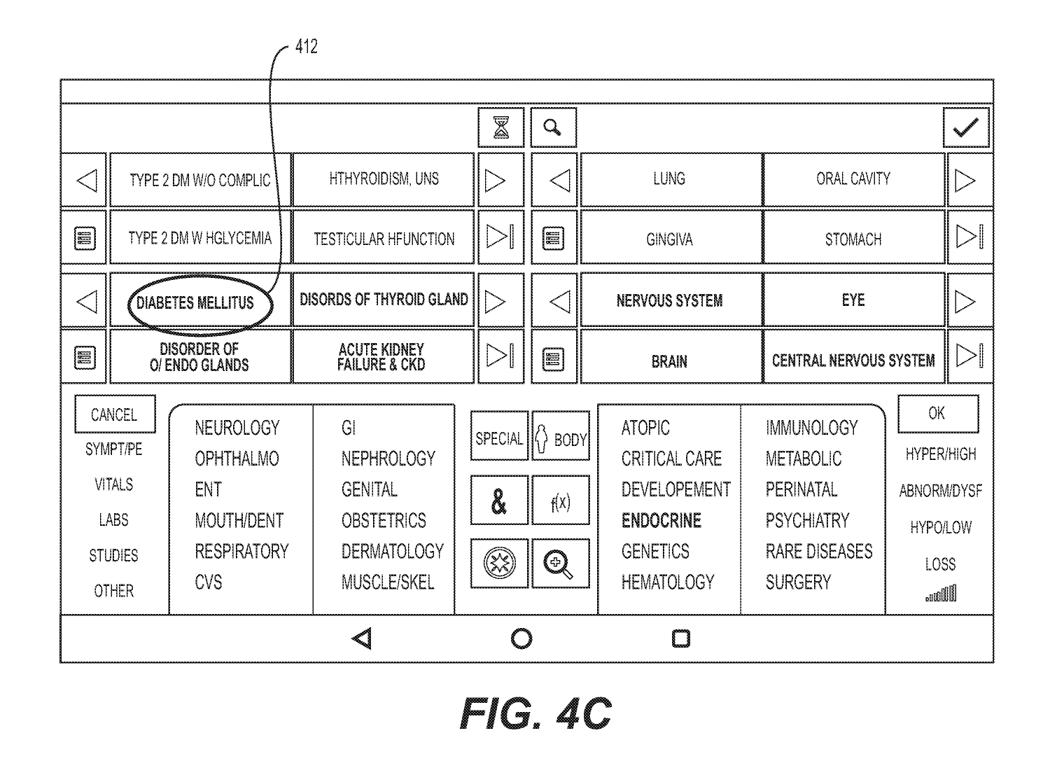

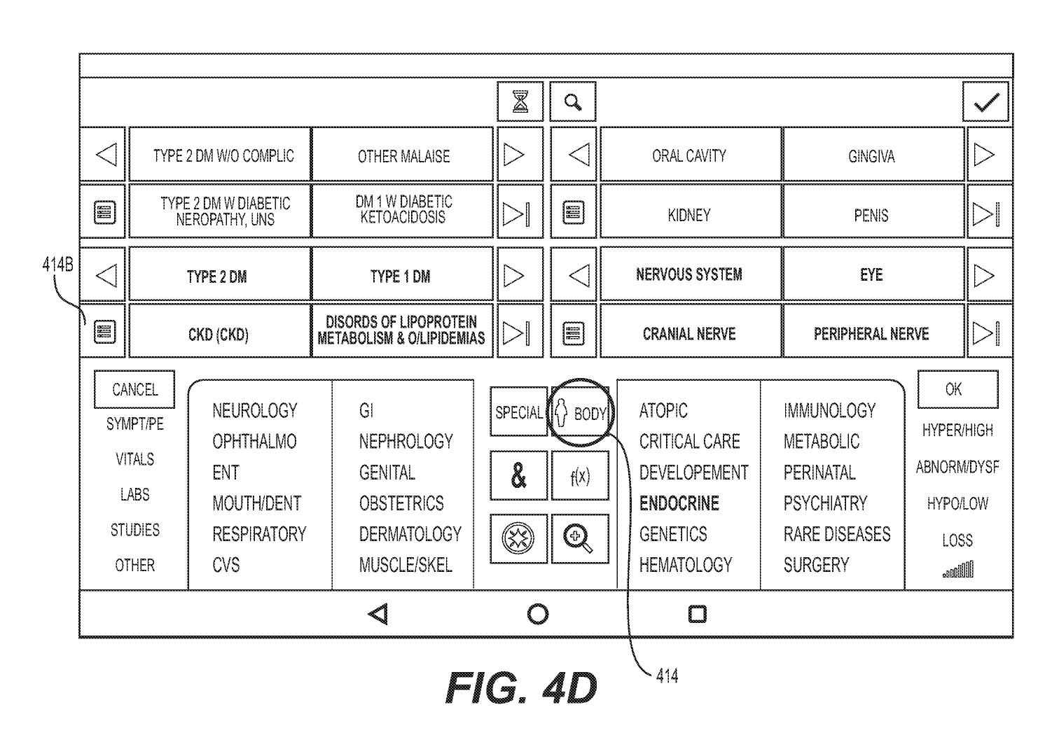

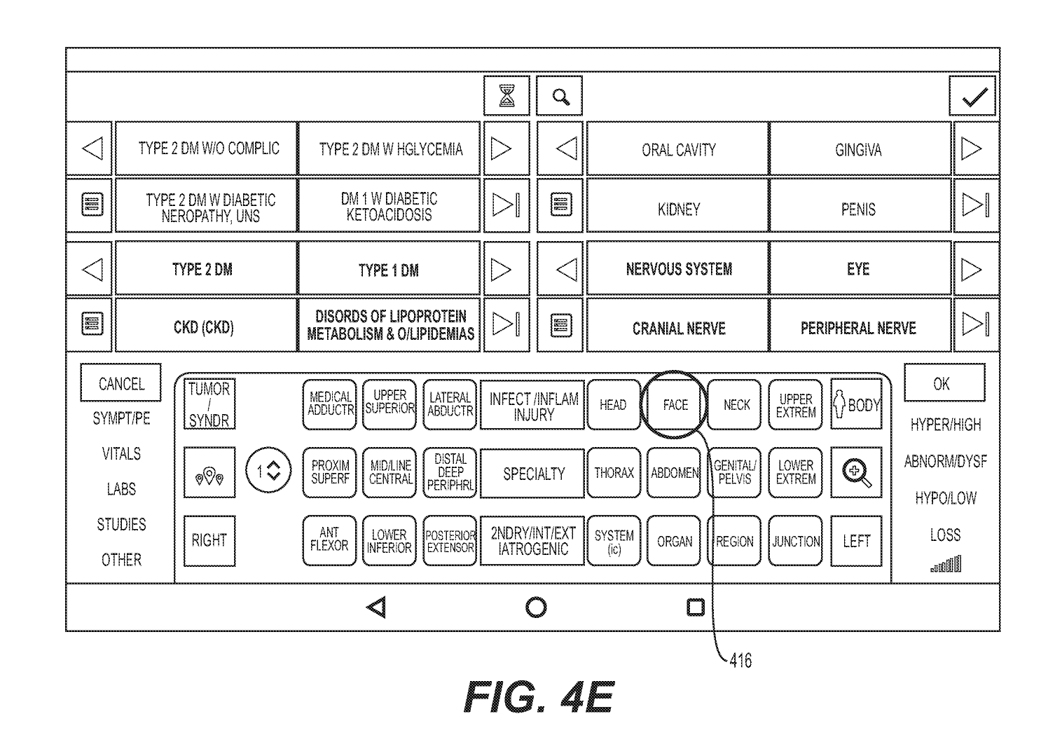

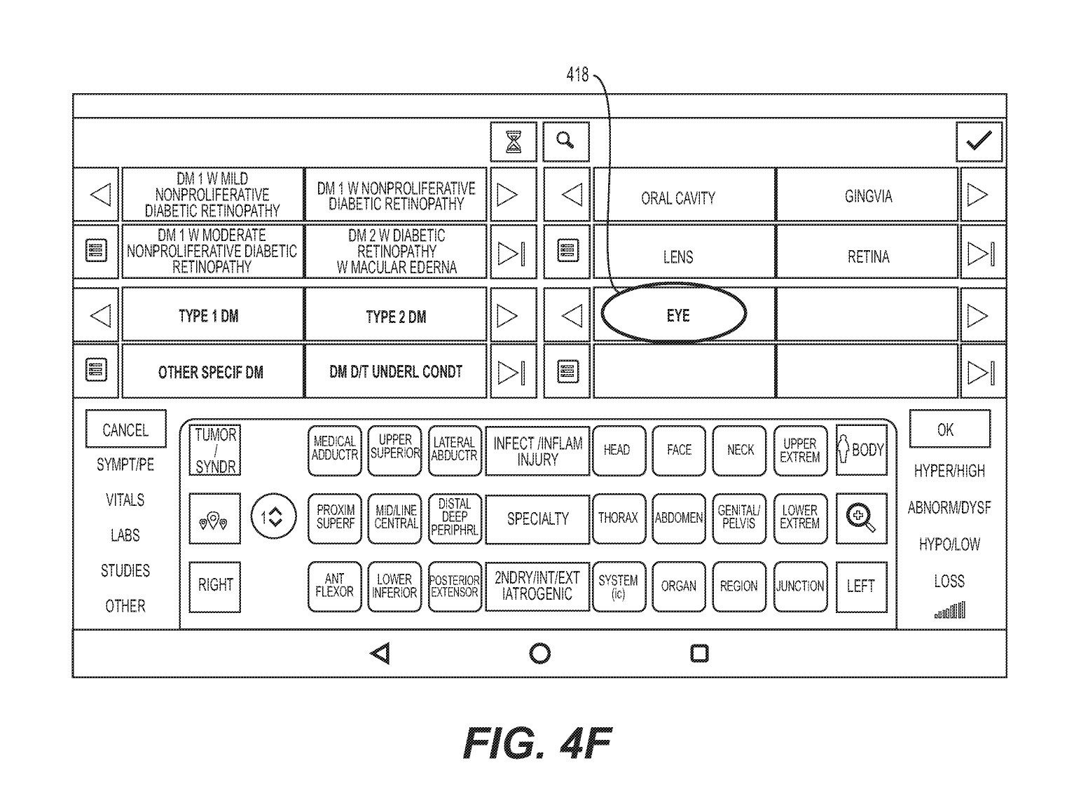

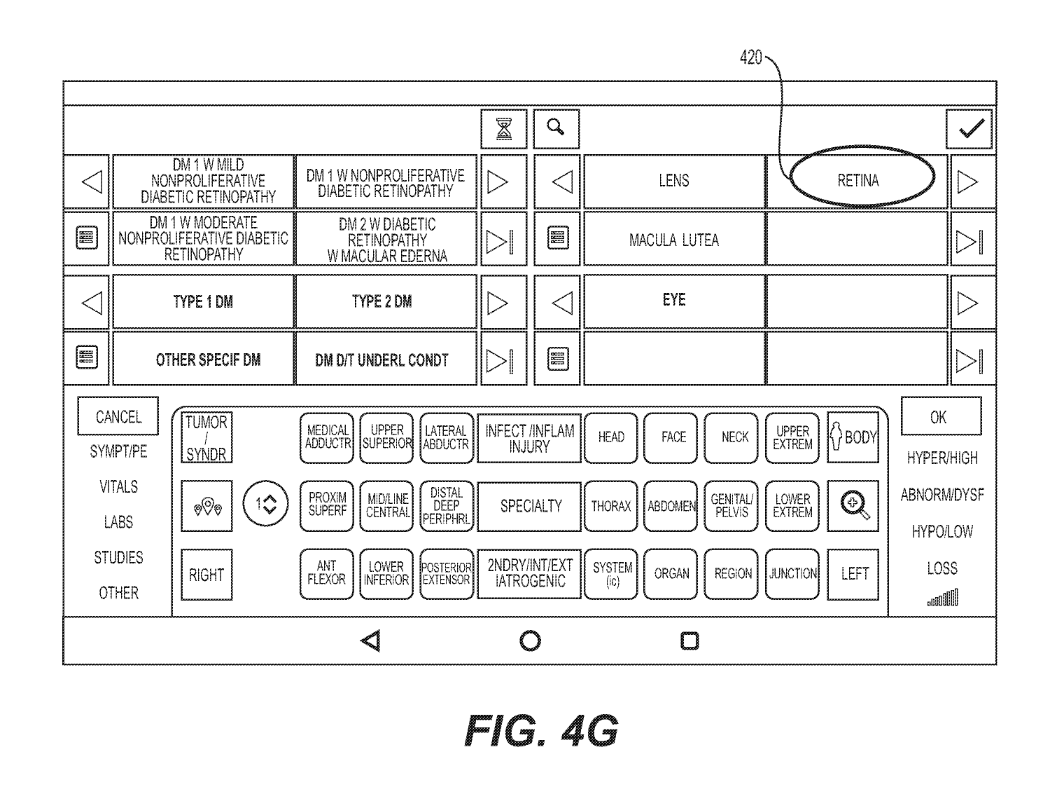

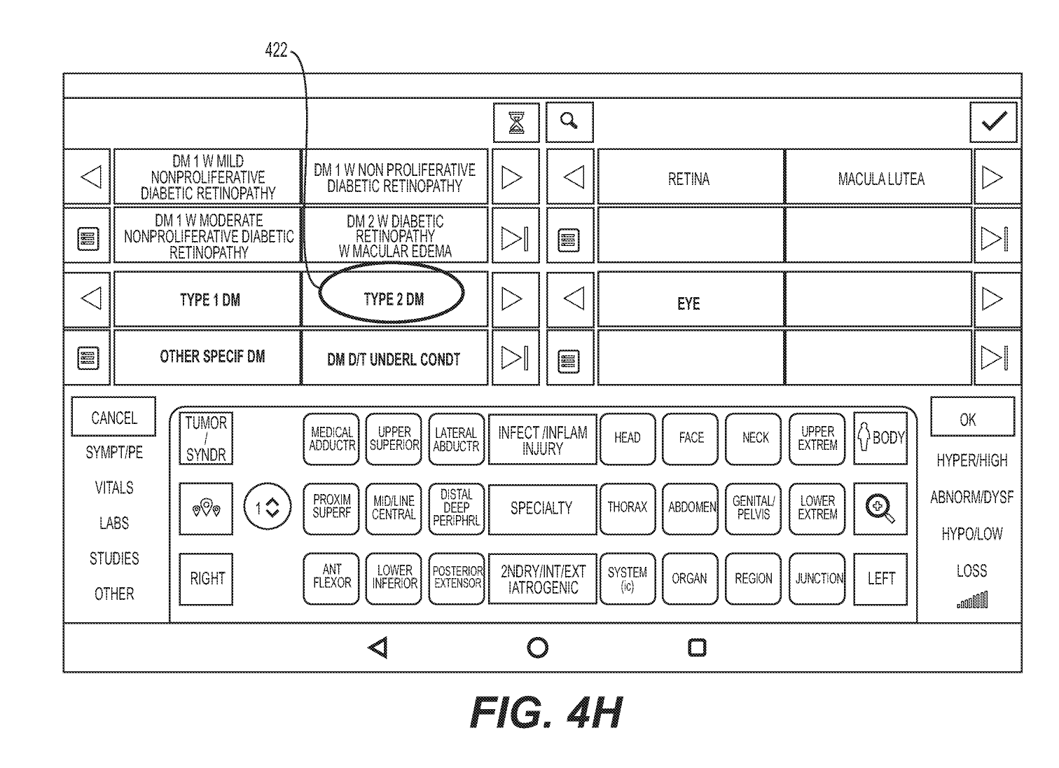

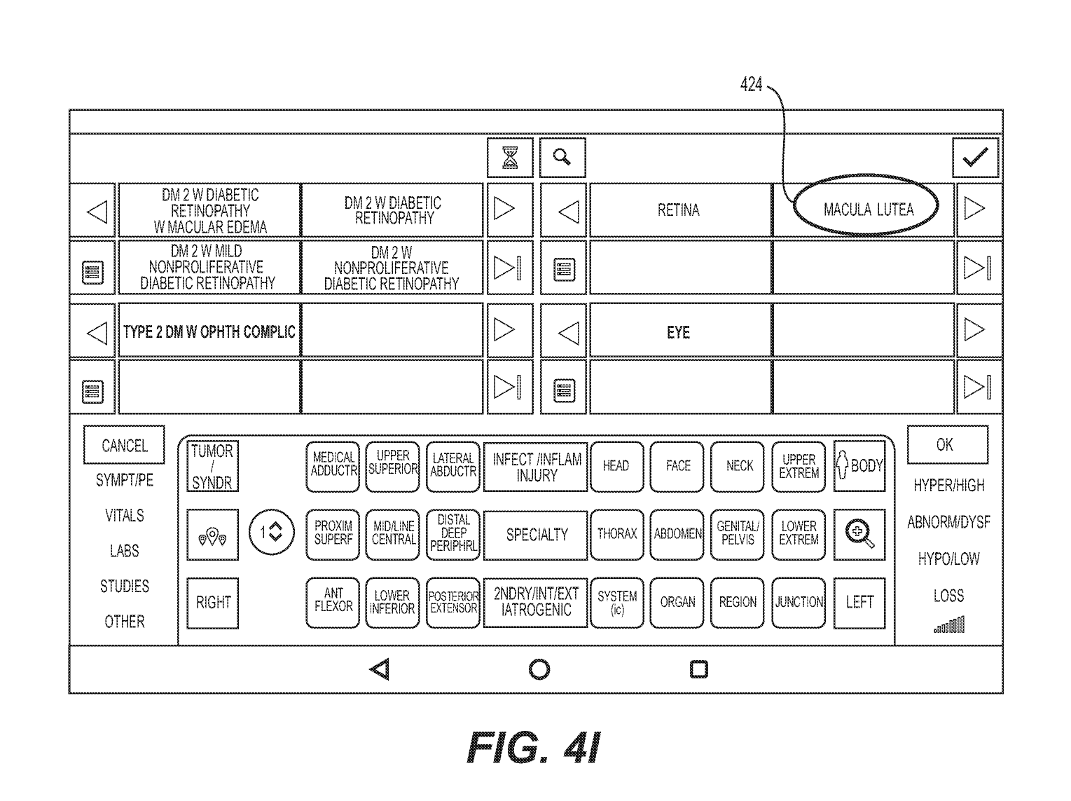

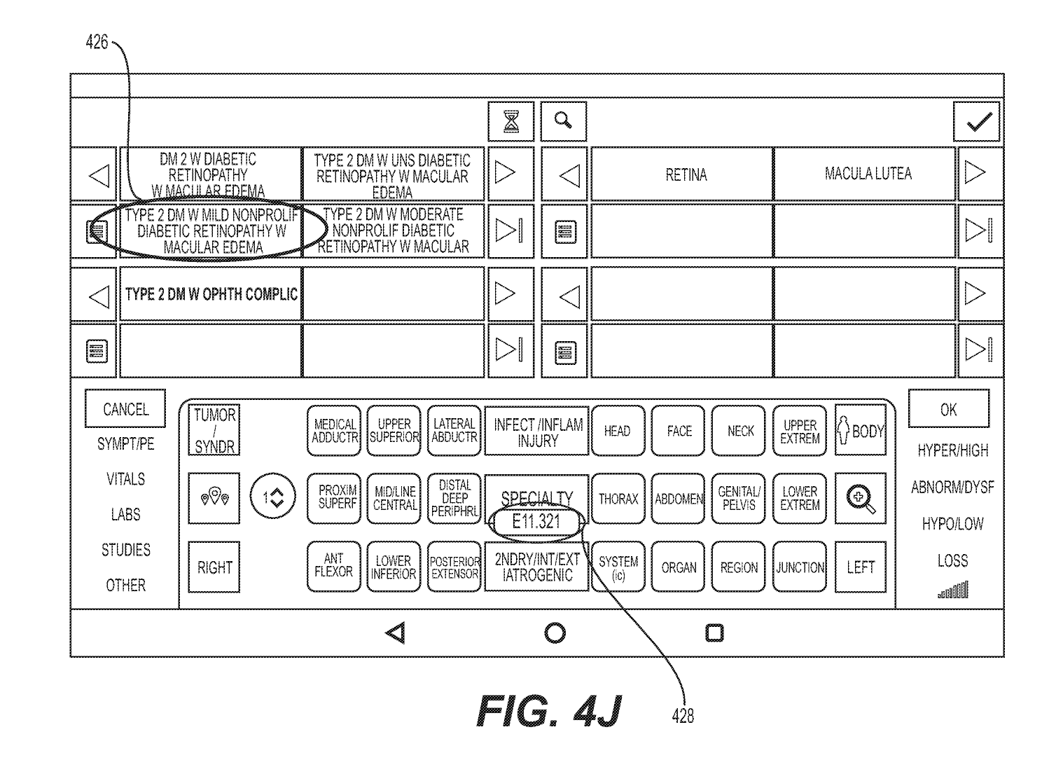

FIGS. 4A-4J are a series of exemplary screenshots depicting an exemplary method of searching for medical codes representing an exemplary medical diagnosis or procedure. For purposes of demonstration, FIGS. 4A-4J represent exemplary screenshots depicting a method of searching for an ICD-10 code for “Diabetes Mellitus 2 with mild non-proliferative diabetic retinopathy with macular edema.” While the sequence of screenshots, as depicted in FIGS. 4A-4J, may illustrate how one user may search, based on the said user's understanding of the medical diagnosis or procedure, there may be other ways of searching for the ICD-10 code for “Diabetes Mellitus 2 with mild non-proliferative diabetic retinopathy with macular edema,” which are not represented in the figures, and which may depend on said other user's understanding of the medical diagnosis or procedure. Either way may result in locating the desired code.

Thus, one user may facilitate a search, by breaking down every code or concept of the medical diagnosis or procedure into its attributes (e.g., the specific, relevant keywords and notions). For example, “Type 2 diabetes mellitus with mild non-proliferative diabetic retinopathy with macular edema” may be first broken down into relevant keywords: “Type 2,” “diabetes mellitus,” “with,” “mild,” “non-proliferative,” “retinopathy,” “macular,” and “edema”. Once the building blocks (elements of communication) are identified, they may be further encoded through a semantic analysis (e.g., based on SNOMED ontology composition grammar) of their role and an identification of the relevant complementary values. For the above example, the following attributes may be assigned: “type 2” may be a property of measurement; “diabetes mellitus” may be disease of “Endocrinology,” a medical specialty; “with” may be ignored and/or be classified as an unapproved attribute; “mild” may be description of severity; “non-proliferative” may be an associated morphology; “retinopathy” may be linked to “retina,” an anatomical site and “pathy,” a pathological process; “macular” may be linked to “macula lutea,” an anatomical site; and “edema” may be a pathological element. Essentially, this may be a syntax de-construction. Therefore, a user may conduct a search based on these attributes and relationships, and the user interface disclosed in the present disclosure may display those attributes and relationships which may be “available” under the current choices made by the user. The user interface may allow a logical and visually intuitive navigation and selection of filters, e.g., allowing users to describe concepts by using a familiar “medical grammar.”

The systems and methods of the present disclosure may enable a user to conduct a search from using minimal information to using very detailed information about a medical diagnosis or procedure, and the search may be performed through one or more of a selection of filters related to ICD-10, a selection of filters related to supporting taxonomies (SNOMED, DSM-5, etc.), an optional lexical search (keyword typing, voice recognition, etc.).

In some embodiments, the history of the successively chosen filters and tags may be available to a user, so that any filter, regardless of its order in the history, may be reset and/or changed, using one or more keyboard functionalities. The availability of this history and the ability to reset and/or change filters may ensure a consistency of results, and/or provide the user with flexibility within the navigation process. As depicted in FIG. 3A, a user may be able to access the history in multiple ways. In one embodiment, a user may be able to view previously selected search results in one of the zones of the hierarchical results area 300A via the prior selections button 308D next to each zone of the hierarchical results area 300A. In another embodiment, a search history icon 308A may allow the user to view the codes and/or descriptive attributes already chosen by the user in a specific time interval. In other embodiments, the user interface may display, at the top of the disease and/or diagnostics side of the hierarchical results area, an indication of the previously selected disease groups, diseases, and/or medical diagnoses or procedures (“breadcrumbs for disease groups and diagnoses” 308B). Likewise, the user interface may display, at the top of the anatomical side of the hierarchical results area, an indication of the previously selected anatomical groups and/or anatomical elements (e.g. “breadcrumbs for anatomical groups and elements” 308C).

Furthermore, a user may be able to view a previously presented offering of search results and/or descriptive attributes by selecting highlighted and/or activated buttons in the filters and tags area or the hierarchical results area, and/or by selecting a descriptive attribute from the breadcrumbs areas, 308B and 308C, at the top of the hierarchical results area.

In some embodiments, the search platform disclosed in the present disclosure may enable a user with the ability to change the value of any attribute, or to remove it altogether, while keeping all the other choices made by the user intact, and reorienting the search using the new filters. For example, “Numerals” may be edited to include values (e.g., five, eleven, etc.) as attributes that had not yet been options before.

In some embodiments, the search platform may be adjusted easily by editing the attributes associated with a concept, or updated altogether, e.g., to reflect changes in medical knowledge or research. For example, AIDS was initially categorized as an immune disease and included in the respective chapter of the coding system. Later on, when HIV was discovered and AIDS became known as an infectious disease, AIDS was relocated altogether to another chapter of the coding system. With systems and methods described in the present disclosure, a concept's attributes may be rapidly adapted to the new reality. The multidimensional search methodology described in the present disclosure may also help in the ongoing effort of improving ICD's structure (e.g., by shaping the development of a future version of ICD, e.g., ICD-11).

Referring to FIG. 4A, a user may begin a search for the code for a medical diagnosis or procedure (e.g., “Type 2 diabetes mellitus with mild non-proliferative diabetic retinopathy with macular edema”) by selecting a filter and/or tag, e.g., specialty 402. A selected button representing a filter and/or tag, e.g., specialty, may turn a different color, e.g., orange, to indicate that the filter and/or tag has been selected. In some embodiments, at the time a user may be starting a search, the upper left zone of the hierarchical results area may display the most frequently used and/or the most recently used ICD-10 codes. The lower left zone of the hierarchical results area may display the hierarchical groups in which the codes from the upper left zone may belong to. The upper right zone of the hierarchical results area may display the anatomical elements most frequently searched for, most recently used, and/or most connected to the ICD-10 codes of the upper left zone. The lower right zone of the hierarchical results area may display the hierarchical anatomical groups in which the anatomical elements of the upper right zone may belong to.

As depicted in FIG. 4B, the selection of “Specialty” (abbreviated as “Special” in the updated display), may open a submenu of options for specialty, from which a user may select ‘Endocrine’ 410. Additionally, as depicted in FIG. 4C, the user interface may react to the selection of ‘Endocrine’ by changing the offerings at the hierarchical results area. This feature demonstrates that the filters and tags area and the hierarchical results area dynamically filter with one another through the search process. Thus, the upper left zone of the hierarchical results area, which displays the final ICD-10 codes, may be populated by some of the ICD-10 codes that may be considered to fall within the specialty of “Endocrine” (e.g., “Type 2 DM w/o complic,” “Type 2 DM w Hglycemia,” “hthyroidism, Uns,” “Testicular hfunction,” etc.). In addition, the button “Endocrine” may be highlighted to indicate that it has been recently selected. In some embodiments, the particular selection of the particular ICD-10 codes to populate a 2×2 grid based on the recent filters chosen by a user may be based on, for example, the search history of a user, most commonly chosen search terms, an alphanumeric method of selection, a random method of selection, etc.

The lower left zone of the hierarchical results area, which displays the hierarchical disease groups corresponding to the ICD-10 codes displayed in the upper left zone, may be populated by disease groups that may be considered to belong within the specialty of “endocrine.” The particular selection of disease groups to populate a 2×2 grid based on the recent filters chosen by a user may be based on, for example, the search history of a user, most commonly chosen search terms, an alphanumeric method of selection, a random method of selection, etc.

The upper right zone of the hierarchical results area, which displays the anatomical elements corresponding to the ICD-10 codes displayed in the upper left zone, may be populated by anatomical elements corresponding to the ICD-10 codes that may be considered to fall within the specialty of “Endocrine.” The particular selection of anatomical elements to populate a 2×2 grid based on the recent filters chosen by a user may be based on, for example, the search history of a user, most commonly chosen search terms, an alphanumeric method of selection, a random method of selection, etc.

The lower right zone of the hierarchical results area, which displays the anatomical groups corresponding to the ICD-10 codes displayed in the upper left zone and the anatomical elements corresponding to the upper right zone, may be populated by anatomical groups corresponding to the anatomical elements and ICD-10 codes that may be considered to fall within the specialty of “Endocrine”. The particular selection of anatomical groups to populate a 2×2 grid based on the recent filters chosen by a user may be based on, for example, the search history of a user, most commonly chosen search terms, an alphanumeric method of selection, a random method of selection, etc.

A user may choose to select “Diabetes Mellitus” 412 from the list of hierarchical disease groups at the lower left zone. As depicted in FIG. 4D, the selection of “Diabetes Mellitus” may immediately change the offering of buttons in the Hierarchical results area so that the choices within the upper left zone (e.g., ICD-10 codes), lower left zone (e.g., hierarchical disease groups), upper right zone (e.g., anatomical elements), and lower right zone (e.g., anatomical groups), are more related, connected, and/or pertaining to the user's search and/or selection of “Diabetes Mellitus”. In one embodiment, buttons allowing a user to view the history of a search may also be highlighted and/or be accessible to the user.

For example, the prior selections buttons (e.g., 308D in FIG. 3A) next to each zone of the hierarchical results area (e.g., 300A in FIG. 3A) may allow the user to view previously presented search results of a zone in the hierarchical results area. The search history button 308A may allow the user to view the codes and/or descriptive attributes already chosen by the user in a specific time interval. The breadcrumbs for disease groups and diagnoses 308B, and/or the breadcrumbs for anatomical groups and elements 308C may allow the user to view and/or select one of the previously selected disease groups, diseases, and/or medical diagnoses or procedures, or one of the previously selected anatomical groups and/or anatomical elements, respectively.

A user may choose to filter the offerings displayed in the hierarchical results area (“hierarchical results”) further by selecting “Body” 414. The selection may be indicated by a highlight of the button representing “Body” 414. In some embodiments, as depicted in FIG. 4E, the filter “Body” may open a number of options for filtering the hierarchical results by a part, region, or element of a body or a further selection pertaining to the body (e.g., head, face, neck, thorax, abdomen, genital/pelvis, lower extremities, system, organ, region, junction, medial, upper, lateral, proximal (abbreviated as “proxim”), mid/line, distal, peripheral, anterior, lower, posterior, etc.). In order to refine the results further based on a part, region, or element of a body, a user may choose “face” 416. As a result of the selection, “Face” may be highlighted. In some embodiments, the previous choices of a search may still be available (e.g. specialty, or the full filter list).

As depicted in FIG. 4F, the selection of “face” 416 may change the upper right zone (e.g., hierarchical anatomical elements) to reveal anatomical elements connected to and/or related to the face (e.g., oral cavity, gingiva, lens, retina). Furthermore, the selection of “face” 416 may also change the lower right zone (e.g., hierarchical anatomical groups) to reveal anatomical groups corresponding to the ICD-10 codes that may be considered to fall under the endocrine specialty, which may occur at or is connected to the face, and corresponding to anatomical elements, which may be connected to and/or related to the face.

Subsequently, a user may select the anatomical group “eye” 418 at the lower right zone, which may result in “eye” being highlighted. As depicted in FIG. 4G, the selection of anatomical group “eye” 418 results in new choices of anatomical elements in the upper right zone (e.g., lens, retina, macula lutea, etc.). In some embodiments, as depicted in FIG. 4G, the anatomical elements displayed in the upper right zone may belong to a recently selected anatomical group (e.g., eye).

Subsequently, a user may select the anatomical element “retina” 420 at the upper right zone. As depicted in FIG. 4H, the selection of an anatomical element (e.g., retina) may result in filtering anatomical elements that may not belong to, or be related to the selected anatomical element (e.g., lens no longer exists in the upper right zone).

A user may search further by selecting a disease group (e.g., Type 2 DM 422). As depicted in FIG. 4I, the selection of a disease group (e.g., Type 2 DM 422) may result in filtering the disease groups that may not belong to, or be related to the selected disease group (e.g., Type 1 DM, Other specif DM, and DM d/t underl condt no longer exist in the lower left zone). A user may search further by selecting an anatomical element (e.g., macula lutea 424), which may result in the highlighting of the selected anatomical element (e.g., macula lutea 424)

As depicted in FIG. 4J, the selection of an anatomical element (e.g., macula lutea 424) may result in filtering the ICD-codes in the upper left side further. As a result of the user's searches, the ICD-codes may now be limited to those belonging to a particular specialty (“endocrine”), related to a disease group (“diabetes mellitus”) restricted to a body part, region, or mode of selection (“face”), limited to an anatomical group (“eye”), limited to an anatomical element (“retina”), be of a particular disease group (Type 2 Diabetes Mellitus, abbreviated as “Type 2 DM”), and further limited to an anatomical element (“macula lutea”). At this point of the search process, if a user has found the desired medical diagnosis or procedure, the user may select it, for example at the upper left zone, which contains names for the ICD-10 codes (e.g., Type 2 Diabetes Mellitus with mild nonproliferative diabetic retinopathy with macular edema, abbreviated as “Type 2 DM w mild nonprolif diabetic retinopathy w macular edema” 426). When a user selects the name or description for the ICD-code of the desired medical diagnosis or procedure, the corresponding alphanumerical ICD-code 428 may appear. In some embodiments, the name or description for the ICD-code and/or the corresponding alphanumerical ICD code may be stored to an electronic storage medium. Subsequently, the user may continue searching, start a new search, or modify the filters of the recent search.

Thus, in the exemplary path of searching for the medical diagnosis, Type 2 Diabetes Mellitus with mild nonproliferative diabetic retinopathy with macular edema 420, the selections were specialty, endocrine, diabetes mellitus, body, face, eye, retina, Type 2 DM, and macula lutea, followed by a scroll through the results (if not available in the initial group of four results displayed in the grid) to find the right code, and then selecting the wanted code.

The systems and methods of the present disclosure offer a flexibility in the way a user may reach a desired medical diagnosis or procedure represented by a ICD-10 code, for example, “Diabetes Mellitus 2 with mild non-proliferative diabetic retinopathy with macular edema.” A user may be able to choose other paths (filters), for example going after “edema” through “Pathology.”

A user may still start by clicking the “Specialty” 402 button in the initial screen, as depicted in FIG. 4A. As a list of “Specialties” appears, as depicted in FIG. 4B, the user may still choose the “Endocrine” 410 filter. The user interface can then react to a user pressing “OK” or “Specialty” (after a user has selected “Endocrine” 410) to return to the initial filters and tags menu. Like the example already described, the Hierarchical Results area may be affected by the user's recent selection, by displaying a list with terms corresponding to Endocrine disorders. For example, the upper left area may display the medical diagnoses and procedures of the ICD-10 codes corresponding to the endocrine specialty. The lower left area may display the hierarchical groups in which the ICD-10 codes of the upper left area belong to. The upper right area may display the anatomical elements corresponding to the endocrine specialty. The lower right area may correspond to the anatomical groups in which the anatomical elements of the upper right area may belong to.

However, in one embodiment, different from the examples described in FIGS. 4A-4I, a user may subsequently select “Pathology.” The user interface may react to the selection of “Pathology” by displaying a list of Pathology terms corresponding to Endocrine disorders. The user may now scroll through the Pathology terms list to identify “edema.”

The user interface may react to the selection of “Edema” by displaying a list of Pathology terms corresponding to Endocrine disorders associated with edema:

For example, the upper left zone of the hierarchical results area may display the ICD-10 codes for endocrine disorders having “edema.” The lower left zone of the hierarchical results area may display the hierarchical groups in which the ICD-10 codes in the upper left zone may belong to. The upper right zone may display the anatomical elements which may be components of endocrine disorders having “edema.” The lower right zone may display the anatomical groups in which the anatomical elements of the upper right zone may belong to.

A user may then choose to select “Diabetes Mellitus” from the hierarchical groups in the lower left zone. The user interface may react to the selection of “Diabetes Mellitus” by displaying the types of diabetes mellitus in the lower left zone of the hierarchical results area, which may be hierarchical groups under which ICD-10 codes found in the upper left zone may belong to. Thus, the upper left zone of the hierarchical results area may display ICD-10 codes for Diabetes Mellitus having “edema” while the lower left zone may display Groups/types of Diabetes Mellitus having “edema.” The upper right zone of the hierarchical results area may display the anatomical elements which may be components for Diabetes Mellitus having “edema.” The lower right zone of the hierarchical results area may include the hierarchical anatomical groups under which the anatomical elements of the upper right zone may belong to.

Subsequently, the user may select the desired type of Diabetes Mellitus, “Type 2 DM,” in the lower left zone of the hierarchical results area. The user interface may react to the selection of “Type 2 DM” by displaying the types of Type 2 Diabetes Mellitus (Type 2 DM), in the lower left zone of the hierarchical results area, which may comprise for example, Type 2 DM with ophthalmic complications. The upper left zone of the hierarchical results area may include the ICD-10 codes for medical diagnoses and/or procedures belonging to “Type 2 DM with ophthalmic complications having edema.” The upper right zone of the hierarchical results area may include anatomical elements which may be components of “Type 2 DM with ophthalmic complications having edema.” The lower right zone of the hierarchical results area may include the anatomical groups under which the anatomical elements of the upper right zone may belong to.

Subsequently, the user may select the “Type 2 Diabetes Mellitus with ophthalmic complications” from the lower left zone of the hierarchical results area. The user interface may react to the selection of “Type 2 DM w/ophthalmic complications” by displaying the ICD-10 codes corresponding to “Type 2 DM w/ophthalmic complications,” in the upper left zone of the hierarchical results area. The lower left zone of the hierarchical results area may include the group, “Type 2 DM with ophthalmic complications having edema.” The upper right zone of the hierarchical results area may include anatomical elements which may be components of “Type 2 DM w/ophthalmic complications having edema,” for example, retina and macula lutea. The lower right zone of the hierarchical results area may include the anatomical groups under which the anatomical elements of the upper right zone may belong to.

Subsequently, the user may be able to pick the desired medical diagnosis or procedure from the upper left zone, e.g., “Diabetes Mellitus 2 with mild non-proliferative diabetic retinopathy with macular edema,” while the application displays the corresponding alphanumerical ICD-10 code to the user (e.g., as in 428 in FIG. 4J).

Thus, multiple paths and/or selections may lead to any medical code representing a medical diagnosis or procedure. As demonstrated already by the examples described, obtaining the code does not depend on the order of selections.

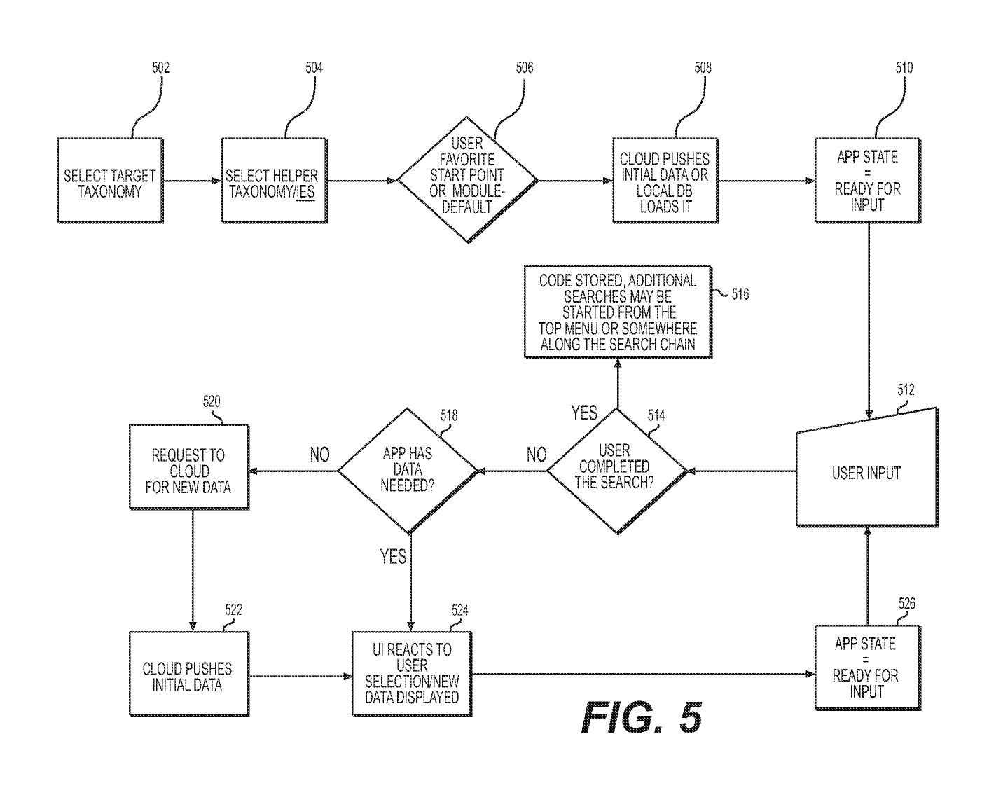

FIG. 5 is a flow diagram of an exemplary process performed by the platform to enable a user to search for medical codes representing a medical diagnosis or procedure, according to an exemplary embodiment of the present disclosure. Thus, FIG. 5 may represent a schema of the search process, from the perspective of the platform and/or application.

To enable the search process, medical codes representing a medical diagnosis or procedure may be organized and/or registered into the search platform. The organization may include determining the descriptive attributes that each medical code may belong to. For example, the medical code for Type 2 Diabetes Mellitus with mild nonproliferative diabetic retinopathy with macular edema, may include the descriptive attributes of belonging to: the specialty—endocrine; the disease group —diabetes mellitus; the body part, region, or mode of selection—face and abdomen; the anatomical groups—eye and endocrine gland; the anatomical element—retina and macula alutea. As described already, at least some of the embodiments of the present disclosure describe a poly-hierarchical classification of medical codes. Thus, Type 2 Diabetes Mellitus with mild nonproliferative diabetic retinopathy with macular edema may also belong to the particular disease group—Type 2 Diabetes Mellitus, and/or may also belong to the anatomical element—macula lutea. In some embodiments, the descriptive attributes may include categories comprised of other taxonomies and/or descriptive attributes. For example, the descriptive attribute of endocrine specialty may also serve as a category for other descriptive attributes, for example, the disease group Type 2 Diabetes Mellitus.

Therefore, step 502 may include the process of selecting descriptive attributes, including categories comprising other descriptive attributes, for a target code (“selecting target taxonomy”). To maintain the multi-directional nature of the search platform, enabling users to search for a medical code using alternate paths, step 504 may include the process of selecting alternative descriptive attributes, including categories comprising other descriptive attributes that may describe the same target code (“selecting helper taxonomy/ies”).

Moreover, steps 502 and 504 may describe the steps for registering and/or loading a medical code into the platform, to enable the user to be able to search for the medical code.

As shown in step 506, the platform may determine what to display in the initial user interface presented to a user for the search (“start point settings”). The platform may allow the flexibility of starting either from a “blank slate,” or from where the previous session ended, or from a menu presenting the most frequently (or recently) used codes and hierarchical structures. In some embodiments, a user may configure the settings of the user interface for a starting point of the search.

Based on the determined start point settings in step 506, step 508 may include a backend server (e.g., “cloud”) providing the user interface with the data necessary for the initial display labels/buttons. Subsequently, after receiving the necessary data, the platform may be designated as being ready for user input (e.g. as in step 510, “App state=ready for input”).

At step 512, a user may make an input. For example, the user may add and/or reset a filter or tag, select from a menu of options after selecting a filter or tag, select a result from the hierarchical results area, and/or select a (target) medical code that is presented.

At step 514, the application may analyze the user input at step 512, and determine whether the selection was an “end product” of the search (e.g., whether the user selected the desired alphanumerical ICD-10 code), or only a step in the search (e.g. add and/or reset a filter or tag, select from a menu of options after selecting a filter or tag, select a result from the hierarchical results area, etc.).

If, at step 514, the application determines that the user input at step 512 was an end product of the search, step 516 may include storing the code. In some embodiments, step 516 may include enabling the user to initiate additional searches, for example, from a top menu, or from somewhere along the search chain of a recent search. In some embodiments, step 516 may include enabling the user to continue to search for other, related codes, for example, by resetting some chosen filters.

If, at step 514, the application determines that the user input at step 512 was only a step in a search, step 518 may include determining whether the application has the necessary data to populate the display as a reaction to the last input (e.g. “App has data needed” to populate the user interface after a user input of opening a submenu, or scrolling through hierarchical code values).

If, at step 518, the application determines that it has the necessary data to populate the display as a reaction to the last input, step 524 may include the user interface reacting to the user input of step 512. Thus, step 524 may include displaying the new data, as may be requested by the user input. For example, if a user has selected the filter, specialty, as the user input at step 512, step 524 may include displaying a list of options of various specialties for a user to select.

If, at step 518, the application determines that it does not have the necessary data to populate the display as a reaction to the last input, step 520 may include sending a request to the cloud for the necessary data. For example, if the user has selected the filter, specialty, as the user input at step 512, and the application does not have the necessary data to supply the list of specialties, the application may send a request to the cloud to retrieve the list of specialties available to be displayed on the user interface. Subsequently, step 522 may include the cloud pushing the requested data back to the platform and/or application, and the platform and/or application processing the received data for display.

Subsequent to step 522, the application may perform step 524 of the user interface reacting to the user input of step 512 (e.g., by displaying the new data, as may be requested by the user input).

At step 526, the application may return to the “ready for input” state (e.g., as in step 510), waiting for a user input, which would commence step 512 again.

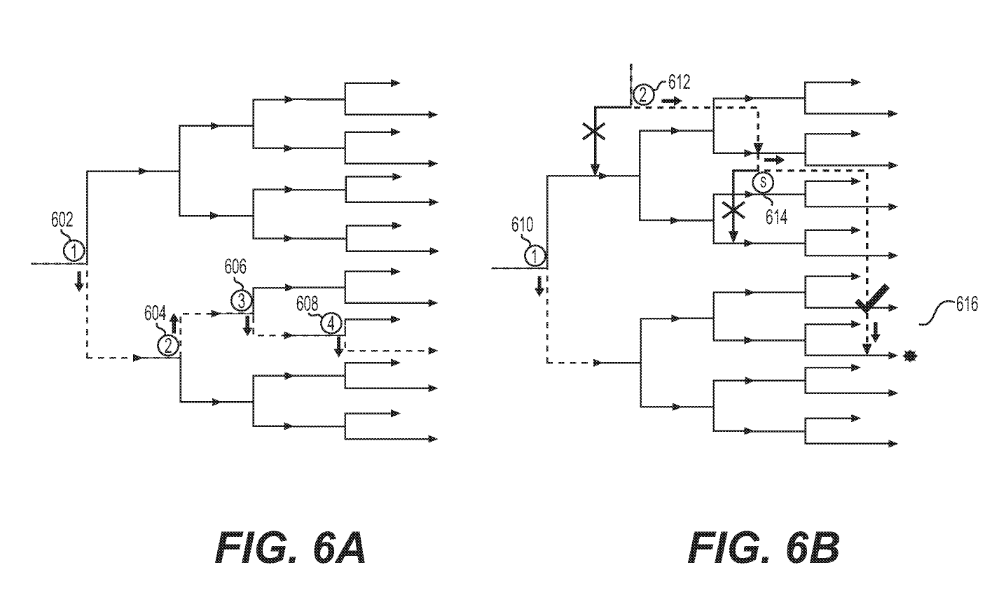

FIGS. 6A-6B are hierarchical tree diagrams that depict and compare two methods of searching for medical codes representing a medical diagnosis or procedure, according to an exemplary embodiment of the present disclosure. In both figures (FIGS. 6A-6B), the dashed lines indicate the path chosen by a user in reaching a desired search result. The forks at each individual hierarchical trees depict potential decision points in the search process, e.g., where a user may be confronted with a choice of filters to select from during a search process. For example, in FIG. 6A, at 602, a user's selection of taking the bottom path restricts all search possibilities to the bottom half of the hierarchical tree.

Moreover, FIG. 6A depicts a method of searching for medical codes that is mono-hierarchical (e.g., one taxonomy). This means that users, in the process of reaching the desired medical code, make search decisions presented to them without a choice, in a predetermined sequence, following decision points (e.g., 602, 604, 606, 608) which depend on all previous points. In the mono-hierarchical search method, reaching the desired medical code is dependent on completing steps 608, 606, 604, and 602, without the jumping of steps.

In contrast, FIG. 6B depicts a method of searching for medical codes that is poly-hierarchical (e.g., multiple taxonomies), as various embodiments of the present disclosure may utilize. One taxonomy is represented by a hierarchical tree flowing from left to right, the hierarchical tree being the same as that depicted in FIG. 6A. Another taxonomy (secondary and/or linked taxonomy) is represented by a hierarchical tree flowing from top to bottom, and its bolder lines distinguish it from the former hierarchical tree. In at least some embodiments of the present disclosure, these multiple taxonomies may be based on the integration of various taxonomies of the ICD-10, SNOMED, DSM-5, and other medical coding languages. This may bring clear search advantages over navigation in a mono-hierarchical tree structure.

As already described in the present disclosure, and abstractly depicted in FIG. 6B, the filters (attributes and relationships) may help users “jump” over several decision steps (for example, lower level steps shown in FIG. 6A), accelerating the process of reaching the desired medical code. For example, a user may choose to make a first choice 610 of the search process based on one taxonomy (represented by the thinner lined hierarchical tree). As depicted in FIG. 6B, the first choice may limit the possibilities of a search to branches of the bottom half of the first hierarchical tree (e.g., the first taxonomy). However, a user may choose to make a second choice by selecting a secondary and/or linked taxonomy, represented by the top- to-bottom aligned, bold hierarchical tree). As depicted in FIG. 6B, the secondary and/or linked taxonomy has two decision points, represented by forks 612, and 614. At fork 612, the left branch ends up in the top half of the hierarchical tree representing the first taxonomy. However, since the first choice of the user has limited the possibilities of search results to only the bottom half of the hierarchical tree representing the first taxonomy, the left branch at fork 612 is closed off, restricting any possibilities of search results to the right branch. As shown in the bold hierarchical tree representing the secondary and/or linked taxonomy, fork 614 is downstream of fork 612 by way of the right branch of fork 612. At fork 614, the left branch also ends up in the top half of the hierarchical tree representing the first taxonomy. For the same reasons already described (e.g., the first choice of the user has limited the possibilities of search results to only the bottom half of the hierarchical tree representing the first taxonomy), the left branch at fork 614 is closed off, restricting any possibilities of search results to the right branch, which leads to the desired result 616. Thus, FIGS. 6A and 6B depict methods of reaching the same desired result (e.g., medical code), but the mono-hierarchical search method, as depicted in FIG. 6A, results in the user making four choices, whereas a poly-hierarchical search method, as depicted in FIG. 6B, enables the user to reach the same desired result by making only two choices and or search selections (e.g., 610 and 612).

The integration of various coding languages and taxonomies inherent within the coding languages (e.g., ICD, SNOMED, DSM), along with the interdependencies of the filters, tags, and hierarchical results of the user interface enable the search method, of at least some embodiments of the present disclosure, to be poly-hierarchical (or multi-hierarchical) in nature. This may enable the user of the platform to search for a medical code representing a medical diagnosis or procedure using one of a plurality of search methods.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for searching medical codes representing medical diagnoses or procedures, wherein descriptive attributes are assigned to each of the medical codes, at least some of the descriptive attributes including categories comprising other of the descriptive attributes, the method comprising:
performing one or more iterations of visually selecting one of the descriptive attributes to produce search results displayed on a keyboard-like user interface, wherein the search results include other descriptive attributes and medical codes; and
selecting the desired medical code from the search results, wherein the one or more iterations includes (1) an order of selecting descriptive attributes and (2) a group of descriptive attributes, and there is more than one order or more than one group of descriptive attributes that can be visually selected to produce a search result.

2. The method of claim 1, wherein visually selecting a descriptive attribute changes one or more of the search results and one or more descriptive attributes displayed in the keyboard-like user interface (UI).

3. The method of claim 1, wherein the desired medical code comprises, one or more of, a medical description of a medical diagnosis or procedure, or a recognized alphanumeric identifier of a medical diagnosis or procedure.

4. The method of claim 1, wherein the method includes performing more than one iterations of visually selecting one of the descriptive attributes to produce search results displayed on the keyboard-like interface.

5. The method of claim 1, wherein the search results displayed on the keyboard-like user interface are divided into one or more zones.

6. The method of claim 5, wherein the one or more zones comprise one or more zones of:
a first zone listing medical codes representing medical diagnoses or procedures;
a second zone listing hierarchical disease groups under which the medical diagnoses or procedures are classified;
a third zone listing anatomical elements or the elements of one or more additional taxonomies; or
a fourth zone listing hierarchical anatomical groups or the hierarchical groups of the elements of the additional taxonomies; under which one or more anatomical elements, medical conditions, or the elements of the additional taxonomies can be classified.

7. The method of claim 5, wherein each of the one or more zones is a grid of search results, and wherein a search result of a zone is based on a most frequently used or a most recently chosen search result based on one or more iterations of visually selecting one or more descriptive attributes.

8. The method of claim 1, wherein each iteration does not include:
a text search,
a user typing a word, or a a voice recognition.

9. The method of claim 1, wherein the during the performing of one or more iterations of visually selecting one of the descriptive attributes to produce search results displayed on the keyboard-like interface, one or more previously selected descriptive attributes can be unselected to produce other search results displayed on the keyboard-like interface.

10. The method of claim 1, wherein the descriptive attributes include, one or more medical concepts like: tumors or syndromes; numeric attributes; orientations; specialties; anatomical elements; body parts; infections, inflammations, or injuries; pathologies; attributes related to the timing of a medical condition; bioperiods; time-patterns of a medical condition; status of a medical condition or procedure; attributes related to being external, internal, or iatrogenic; symptoms; physical examinations; vitals; labs; studies; attributes related to hyper, high, hypo, or low; abnormalities or dysfunctions; attributes related to loss; or a combination thereof.

11. A system for searching medical codes representing medical diagnoses or procedures, the system comprising:
a data storage device storing instructions for enabling a user to search for a desired medical code of the medical codes;
a user interface enabling the user to search for the desired medical code, wherein descriptive attributes are assigned to each of the medical codes, at least some of the descriptive attributes including categories comprising other of the descriptive attributes; and
a processor configured to enable the user of the system to:
perform one or more iterations of visually selecting one of the descriptive attributes to produce search results displayed on a keyboard-like user interface, wherein the search results include other descriptive attributes and medical codes; and
select the desired medical code from the search results, wherein
the one or more iterations includes (1) an order of selecting descriptive attributes and (2) a group of descriptive attributes, and
there is more than one order or more than one group of descriptive attributes that can be visually selected to produce a search result.

12. The system of claim 11, wherein visually selecting a descriptive attribute changes one or more of the search results and one or more descriptive attributes displayed in the keyboard-like user interface (UI).

13. The system of claim 11, wherein the processor is configured to enable the user of the system to perform more than one iterations of visually selecting one of the descriptive attributes to produce search results displayed on the keyboard-like interface.

14. The system of claim 11, wherein the search results displayed on the keyboard-like user interface are divided into one or more zones.

15. The system of claim 14, wherein the one or more zones comprise one or more zones of:
a first zone listing medical codes representing medical diagnoses or procedures;
a second zone listing hierarchical disease groups under which the medical diagnoses or procedures are classified;
a third zone listing anatomical elements or the elements of one or more additional taxonomies; or
a fourth zone listing hierarchical anatomical groups or the hierarchical groups of the elements of the additional taxonomies; under which one or more anatomical elements, medical conditions, or the elements of the additional taxonomies can be classified.

16. The system of claim 14, wherein each of the one or more zones is a grid of search results, and wherein a search result of a zone is based on a most frequently used or a most recently chosen search result based on one or more iterations of visually selecting one or more descriptive attributes.

17. The system of claim 11, wherein the during the performing of one or more iterations of visually selecting one of the descriptive attributes to produce search results displayed on the keyboard-like interface, one or more previously selected descriptive attributes can be unselected to produce other search results displayed on the keyboard-like interface.

18. A method for enabling a user to search for medical codes representing medical diagnoses or procedures, the method comprising:
storing medical codes in an electronic storage medium;
assigning descriptive attributes to each of the medical codes, at least some of the descriptive attributes including categories comprising other of the descriptive attributes;
receiving an input from the user, wherein the input is a selection by a user of one of (a) the descriptive attributes, (b) the medical codes, or (c) the keyboard functionalities to view more descriptive attributes or medical codes, displayed on a keyboard-like user interface, and wherein the input does not include the user typing alphanumeric text of the one of the descriptive attributes, medical codes, or the keyboard functionalities;
if the received input is a descriptive attribute or a keyboard functionality, producing and displaying search results on the keyboard-like user interface, wherein the search results include other descriptive attributes and medical codes; and
if the received input is matched to a medical code, producing and displaying the medical code on the keyboard-like user interface.

19. The method of claim 18, wherein the steps of receiving an input from the user and producing and displaying search results are performed multiple times.

20. The method of claim 18, further comprising, after the step of receiving an input from the user, matching the received input to a descriptive attribute, a medical code, or a keyboard functionality, without performing a text search based on the received input.
